(19) United States
(12) Patent Application Publication
(10) Pub. No.: US 2023/0131020 A1
(43) Pub. Date: Apr. 27, 2023

(54) ADSORBENT FILTER ASSEMBLY FOR AN ELECTRONICS ENCLOSURE

(71) Applicant: Donaldson Company, Inc., Bloomington, MN (US)

(72) Inventors: Joseph M. Block, Carver, MN (US); Daniel L. Tuma, St. Paul, MN (US); Andre D. Leier, Shakopee, MN (US)

(21) Appl. No.: 17/914,020

(22) PCT Filed: Mar. 26, 2021
(86) PCT No.: PCT/US2021/024489

§ 371 Date: Sep. 23, 2022

Related U.S. Application Data
(60) Provisional application No. 63/027,420, filed on May 20, 2020.
(60) Provisional application No. 63/000,705, filed on Mar. 27, 2020.

(51) Int. Cl. B01D 53/04; B01D 53/26

(52) U.S. Cl. CPC B01D 53/0407; B01D 53/261; B01D 2253/102; B01D 2253/104; B01D 2253/304; B01D 2257/80

(57) ABSTRACT

A filter assembly is disclosed that has a body defining a cavity and having a first side edge surface, a second side edge surface, a top edge surface, and a bottom edge surface forming a perimeter surface around the cavity. A porous flow face extends across the cavity and is coupled to the perimeter surface. The porous flow face arcs between the first side edge surface and the second side edge surface. An adsorbent is disposed in the cavity.

This application claims the benefit of U.S. Provisional Application No. 63/000,705, filed Mar. 27, 2020, and U.S. Provisional Application No. 63/027,420, filed May 20, 2020, which are hereby incorporated by reference in their entireties.

### TECHNOLOGICAL FIELD

The present disclosure is generally related to an adsorbent filter assembly. More particularly, the present disclosure is related to an adsorbent filter assembly for an electronics enclosure.

### BACKGROUND

Various situations require conditions that allow the ability to control the amount of moisture in the air. For example, applications within electronics enclosures, such as disk drives, that contain sensitive electronic components and equipment often require that moisture levels within the enclosure be maintained and regulated to operate consistently. An improper level of moisture can interfere with mechanical and electrical operations of the components and equipment.

It can also be desirable to eliminate chemical contaminants within the enclosed environment such as hydrocarbons, siloxane, silanes, organic acids and others. Chemical contaminants can reduce the efficiency and longevity of the components within the electronics enclosure. Such chemical contaminants can enter the enclosure from external sources or be generated within the enclosure during manufacturing or use. In the case of disk drives, the contaminants can gradually damage the drive, resulting in deterioration of drive performance and even complete failure of the drive. Consequently, disk drives typically have one or more filters capable of removing moisture and chemical contaminants in the air within the electronics enclosure, such as adsorbent filters.

An adsorbent filter can be used within the enclosure to remove humidity and chemical contaminants from air within the enclosure. An adsorbent filter can contain various types of adsorbent materials such as silica gel, activated carbon, molecular sieve and the like.

### SUMMARY

The technology disclosed herein relates to an adsorbent filter assembly that is configured to have improved adsorption of moisture and chemical contaminants such as siloxane, silanes, and organic acids. In some embodiments the technology disclosed herein improves the adsorption kinetics within an electronics enclosure to increase adsorption while reducing the generation of turbulent airflow within the enclosure. Improved adsorption kinetics may reduce the impact of contaminants on critical drive components such as, for example, contaminants having reactive chemistries with critical drive components.

Some embodiments of the technology disclosed herein relates to a filter assembly. The filter assembly has a body defining a cavity. The body has a first side edge surface, a second side edge surface, a top edge surface, and a bottom edge surface forming a perimeter surface around the cavity. A porous flow face extends across the cavity and is coupled to the perimeter surface. The porous flow face arcs between the first side edge surface and the second side edge surface. The porous flow face has a height from the bottom edge to the top edge that is greater than 14 mm. An adsorbent is disposed in the cavity.

In some such embodiments, the adsorbent has activated alumina. Additionally or alternatively, the adsorbent has carbon. Additionally or alternatively, the porous flow face defines a portion of an inner cylindrical surface. Additionally or alternatively, the porous flow face has a microporous membrane. Additionally or alternatively, the body is impermeable. Additionally or alternatively, the porous flow face defines both an inlet and an outlet of the filter assembly. Additionally or alternatively, the porous flow face defines a radius ranging from 47 mm to 51 mm. Additionally or alternatively, the filter assembly lacks adhesive. Additionally or alternatively, the body is rigid. Additionally or alternatively, the body is constructed of plastic. Additionally or alternatively, the filter assembly has an adhesive layer coupled to an outer surface of the body. Additionally or alternatively, the height of the porous flow face is configured to extend at least 75% of a depth of a corresponding disk drive enclosure.

Some embodiments relate to an electronics enclosure. A housing has a base plate, a cover, a filter receptacle, and a sidewall extending from the base plate to the cover to define an enclosure having a depth. A filter assembly is disposed in the filter receptacle. The filter assembly has a body defining a cavity and a perimeter surface about the cavity. A porous flow face extends across the cavity. The porous flow face is coupled to the perimeter surface. An adsorbent is enclosed between the body and the porous flow face. The porous flow face has a height that is at least 60% of the depth of the enclosure. The porous flow face has a height that that is at least 80% of the height of the body.

In some such embodiments, the porous flow face defines a portion of an inner cylindrical surface across the filter receptacle. Additionally or alternatively, a top edge of the filter assembly abuts the cover and the bottom edge of the filter assembly abuts the base plate. Additionally or alternatively, the porous flow face defines a plane. Additionally or alternatively, the porous flow face is arced between a first side edge and a second side edge of the filter assembly. Additionally or alternatively, the porous flow face is concentric to the disk. Additionally or alternatively, the adsorbent has activated alumina and activated carbon.

Additionally or alternatively, the porous flow face defines an inlet and an outlet of the filter assembly. Additionally or alternatively, the adsorbent has height that spans at least 75% of the enclosure depth. Additionally or alternatively, the electronics enclosure has a gasket disposed in the filter receptacle between the filter assembly and the housing. Additionally or alternatively, the porous flow face has a height that spans at least 80% of the enclosure depth. Additionally or alternatively, the sidewall defines an inner cylindrical surface. Additionally or alternatively, the sidewall defines the filter receptacle. Additionally or alternatively, the filter receptacle is recessed from the inner cylindrical surface. Additionally or alternatively, the body is impermeable.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

FIG. 1 is a perspective view of an example adsorbent filter assembly consistent with various embodiments.

FIG. 2 is one example exploded perspective view consistent with the example of FIG. 1.

FIG. 3 is a simplified top view of an electronics enclosure, consistent with various embodiments.

FIG. 4 is one example cross-sectional view consistent with the top view of FIG. 1.

FIG. 5 is a detail view of a portion of FIG. 4.

FIG. 6 is another simplified top view of an electronics enclosure consistent with various embodiments.

FIG. 7 is yet another simplified top view of an electronics enclosure consistent with various embodiments.

FIG. 8 is a graph of example test results.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

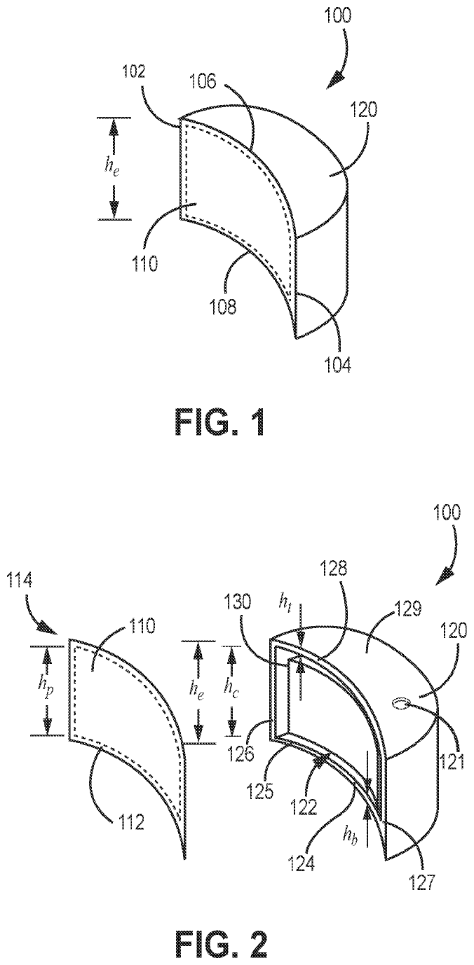

Filter assemblies consistent with the technology disclosed herein can have a variety of different configurations. FIG. 1 depicts one example perspective view of an example filter assembly 100 and FIG. 2 depicts an exploded view consistent with the filter assembly 100 of FIG. 1. The filter assembly 100 is configured to be disposed in a filter receptacle of an electronics enclosure. The filter assembly 100 is generally configured to remove humidity and other chemical contaminants from the electronics enclosure. The filter assembly 100 has a porous flow face 110, a body 120, and an adsorbent 130 enclosed between the porous flow face 110 and the body 120. A “flow face” is defined as a surface that accommodates airflow and diffusion therethrough and has an area of at least 10 mm². “Porous” is defined as having a plurality of void spaces through which air diffuses.

The filter assembly 100 has a body 120 coupled to the porous flow face 110. The body 120 is generally configured to receive the adsorbent. The body 120 defines a cavity 122 The body 120 is not generally configured for use in filtration. As such, in some embodiments, the body 120 is impermeable to air flow therethrough. By “impermeable to air flow” it is meant that the body is substantially resistant to air flow therethrough. More particularly, “impermeable to air flow” is used to mean that the component has a Frazier air permeability of less than 0.05 feet/minute at a pressure drop of 0.5 inch of water. In some other embodiments, the body 120 is permeable to fluid flow, such as airflow. In some such implementations, the system within which the body 120 is installed obstructs fluid flow through the body 120.

The body 120 can have a variety of configurations while remaining consistent with the technology disclosed herein. In the current example embodiment, the body 120 defines a portion of an oval cylinder defining the cavity 122. In some other embodiments, the body 120 can define alternate shapes, however.

The body 120 can be constructed of a variety of materials and combinations of materials while remaining consistent with the technology disclosed herein. In some embodiments the body 120 is rigid. A rigid configuration may advantageously facilitate placement of the filter assembly 100 in the environment in which it will be used, such as a disk drive. A rigid configuration may advantageously facilitate addition of the adsorbent 130 to the cavity during manufacture of the filter assembly 100. In some embodiments, the body 120 is constructed of plastic or metal, as examples. In some embodiments, the body 120 is constructed of a molded plastic. The body 120 can be polycarbonate. The body 120 can be nylon. In some other embodiments where the body 120 is constructed of a permeable material, the body 120 can be constructed of a microporous membrane or sintered plastic, as examples.

The body 120 has a perimeter surface 124 about the cavity 122. The perimeter surface 124 is generally configured to be coupled to the porous flow face 110 such that the porous flow face 110 extends across the cavity 122. The perimeter surface 124 can be an outwardly-facing surface surrounding the cavity 122. In this example, the perimeter surface 124 has a first side edge surface 126, a second side edge surface 127, a bottom edge surface 125 and a top edge surface 128 (visible in FIG. 2). In the current example, the bottom edge surface 125 and the top edge surface 128 each arc inwardly relative to the body 120. The first side edge surface 126 and the second side edge surface 127 are generally planar. In some embodiments, the body 120 does not define more than a single opening that accommodates airflow between the outside environment (for example, a disk drive enclosure) and the cavity.

In some embodiments, the filter assembly 110 does not define more than a single porous flow face that accommodates fluid communication (airflow and/or diffusion) between the outside environment and the cavity 122. In some embodiments the body 120 can also define a breather port 121 (FIG. 2 only) to accommodate airflow between the outside environment and the cavity 122. The breather port 121 is not a porous flow face. In various examples, the breather port 121 is not porous. In embodiments, the breather port 121 can include a diffusion channel extending to the cavity 122. In some examples the breather port is sealed to a housing defining an enclosure (such as a disk drive enclosure, which is described in more detail, below) with a gasket or adhesive label about a housing opening such that the breather port is in diffusive communication with an environment outside of the enclosure. The breather port generally has a maximum cross-dimension (such as a maximum diagonal or diameter measurement) of no more than 3 mm. The porous flow face 110 is generally has a cross-dimension of greater than 10 mm, 15 mm, or 20 mm. The porous flow face 110 can have a maximum cross-dimension that is limited by the size of the environment within which the filter assembly 110 is used such as, for example, a disk drive enclosure.

The body 120 generally has a height that defines the height hₑ of the filter assembly 100. The height hₑ of the body 120 can be equal to the sum of the height hₜ of the top edge surface 128, the height h_{b} of the bottom edge surface 125 and the height h_{c} of the cavity 122. The body 120 (and, therefore the filter assembly 100), can have a height hₑ ranging from 10 mm to 90 mm. The body 120 can have a height hₑ of 25 mm, or 50-51 mm, or 12-13 mm. The body 120 can have a height hₑ of at least 12 mm or 15 mm. The body 120 can have a height hₑ of no more than 90 mm. In some embodiments, the body 120 has a height hₑ of 17 mm to 24 mm. In some example implementations, the filter assembly 100 is configured to be installed in a disk drive and has a height hₑ that is configured to span the depth of the enclosure defined by the disk drive, which will be described in more detail, below.

The height hₜ of the top edge surface 128 and the height h_{b} of the bottom edge surface 125 can each be equal to a thickness of the body 120, in some embodiments. The thickness of the body 120 can be at least 0.5 mm. The thickness of the body 120 can be no more than 1.2 mm. The thickness of the body 120 can be 1.0 mm in various embodiments. In some embodiments, the height hₜ of the top edge surface 128 and the height h_{b} of the bottom edge surface 125 of the body 120 are unequal. In some embodiments, the height hₜ of the top edge surface 128 and the height h_{b} of the bottom edge surface 125 of the body 120 can each range from 0.5 mm to 1 mm.

The body 120 and the porous flow face 110 mutually define the cavity 122 between them. The porous flow face 110 abuts the cavity 122 to allow airflow between the cavity 122 and the environment external to the filter assembly 100. The porous flow face 110 is generally coupled to the body 120. In particular, porous material 114 defining the porous flow face 110 has a perimeter region 112 that is coupled to the perimeter surface 124 of the body 120. The thickness of the perimeter region 112 can be about equal to the thickness of the body 120. Particular to this example, the first side edge surface 126, the second side edge surface 127, the top edge surface 128 and the bottom edge surface 125 of the body 120 are coupled to the perimeter region 112 of the porous material 114 forming the porous flow face 110. The porous material 114 and the perimeter surface 124 can be coupled with adhesive, welds such as ultrasonic welds or heat welds, and the like. In some embodiments the body 120 and the porous material 114 are coupled through an overmolding process.

The filter assembly 100 has a first side edge 102, a second side edge 104, a top edge 106 and a bottom edge 108 (FIG. 1). The body 120 and the porous flow face 110 are coupled along the first side edge 102, the second side edge 104, the top edge 106 and the bottom edge 108. The body 120 and the porous flow face 110 can be coupled through a variety of approaches known in the art such as adhesives, heat welding, ultrasonic welding, and the like.

The porous flow face 110 is configured to accommodate airflow therethrough including water vapor and chemical contaminants. The porous flow face 110 can be constructed of a variety of different materials and combinations of materials. The porous flow face 110 can be vapor-permeable to allow vapors to pass into the filter assembly 100. Because the porous flow face 110 accommodates airflow through it and the body 120 is not configured to filter airflow through it, the porous flow face 110 defines both an inlet and an outlet of the filter assembly 100. In various embodiments, filter assembly 100 defines a single inlet and a single outlet.

The porous flow face 110 can be a variety of different materials and combinations of materials. In some embodiments the porous flow face 110 is a fibrous filter material with or without a supportive scrim layer. For example, the fibrous filter material can be an electrostatic filtration media, for example. The porous flow face 110 can be configured to obstruct the flow of liquid water therethrough. In some, but not all, embodiments the porous flow face 110 is substantially impermeable to liquid water. The porous flow face 110 can be a microporous material, where the term “microporous” is intended to mean that the material defines pores having an average pore diameter between 0.001 and 5.0 microns. The porous flow face 110 can define pore sizes ranging from 0.05 to 5.0 microns, 0.2 to 4.0 microns, or 0.5 to 3.0 microns. In one example, the porous flow face 110 has an average pore size of 1.5 microns. In one example, the porous flow face 110 has a maximum pore size of 3.0 microns.

In some embodiments, the porous flow face 110 can have a solidity of less than 50% and a porosity of greater than 50%. The porous flow face 110 can have a plurality of nodes interconnected by fibrils. In a number of embodiments the porous flow face 110 is an expanded polytetrafluoroethylene (PTFE) membrane. The porous flow face 110 can additionally or alternatively be constructed of polyamide, polyethylene terephthalate, acrylic, polyethersulfone, and/or polyethylene, as other examples.

The porous flow face 110 can be a laminate or composite that includes a breathable membrane, such as a PTFE layer, laminated to a woven or non-woven support layer. In some embodiments, the porous flow face 110 can have a PTFE layer coupled to a scrim layer. In some embodiments, the porous flow face 110 can have three layers, such as a PTFE layer that is positioned between two scrim layers. In some other embodiments, the porous flow face 110 can have three layers, where a single scrim layer is laminated between two PTFE layers. The scrim layer is generally configured to increase the strength and/or stiffness of the membrane. In one embodiment the scrim layer is polyester. The scrim layer can also be other materials and combinations of materials such as, for example, PE, PET, and polypropylene.

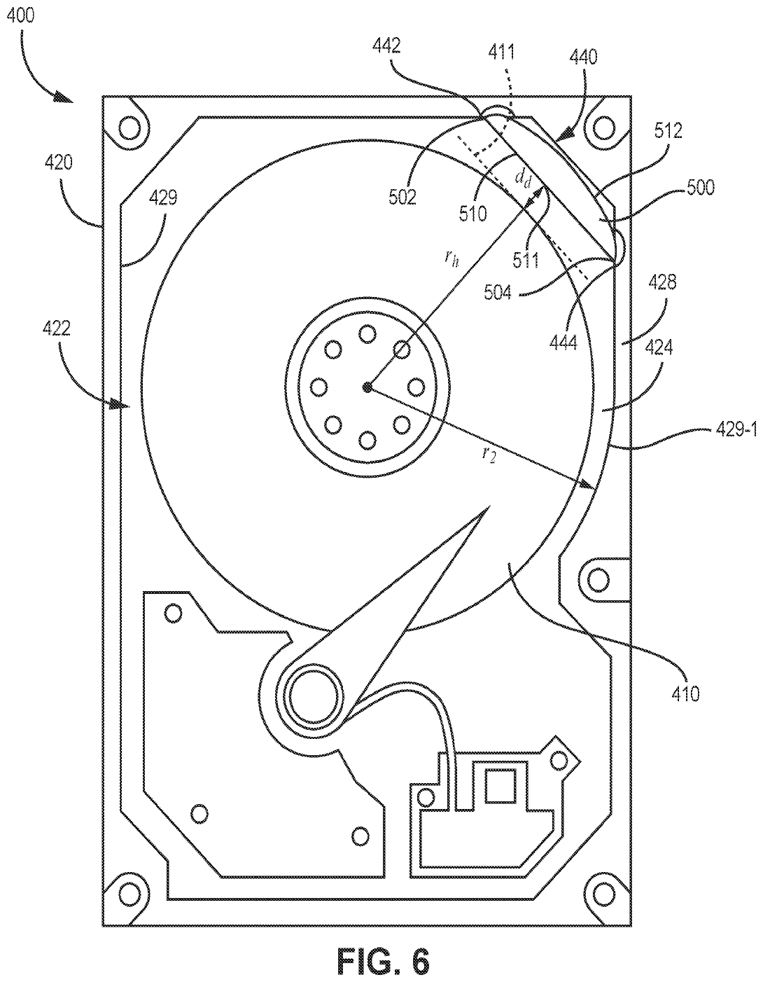

The porous flow face 110 defines a portion of an inner cylindrical surface. The porous flow face 110 arcs between the first side edge surface 126 and the second side edge surface 127 of the body 120. Furthermore, the top edge 106 and the bottom edge 108 of the filter assembly 100 form concentric arcs between the first side edge surface 126 and the second side edge surface 127 of the body 120. In some alternate embodiments, the porous flow face forms a flat plane, as will be described below with reference to FIG. 6.

In various embodiments, by virtue of being directly bonded to the body 120, the perimeter region 112 of the porous material 114 forming the porous flow face 110 does not accommodate airflow there through. As such, the porous flow face 110 is considered to be the region of the porous material 114 that is not directly bonded to the body 120. Correspondingly, the height hₚ of the porous flow face 110 extends between the top edge surface 128 and the bottom edge surface 125 of the body 120. In other words, the height hₚ of the porous flow face 110 of the filter assembly 100 lies within the perimeter region 112 of the porous material 114 such that the perimeter region 112 of the porous material 114 is outside of the height hₚ of the porous flow face 110. The height hₚ of the porous flow face 110 is generally greater than 6 mm. The height hₚ of the porous flow face 110 can be at least 10 mm. In some embodiments, the height hₚ of the porous flow face 110 can be no more than 89 mm. In some embodiments, the height hₚ of the porous flow face 110 is at least 14 mm, 16 mm, 19 mm, or 22 mm. In some embodiments, the height hₚ of the porous flow face 110 no more than 25 mm, 35 mm, 45 mm or 49 mm. In some embodiments, the height hₚ of the porous flow face 110 ranges from 15 mm to 50 mm.

The height hₚ of the porous flow face 110 is generally at least 80% of the height hₑ of the body 120. In some embodiments the height hₚ of the porous flow face 110 is generally 90% or more of the height hₑ of the body 120. The height hₚ of the porous flow face 110 can range between 85%-95% or 90%-97% of the height hₑ of the body 120, in some embodiments.

The length of the porous flow face 110 is defined by the inner boundary of the perimeter region 112 of the porous material 114 between the first side edge surface 126 and the second side edge surface 127. The length of the porous flow face 110 can range from 10 mm to 39 mm, but in various embodiments the length of the porous flow face 110 is not particularly limited. The length of the filter assembly 100 extends between the first side edge 102 and the second side edge 104 of the filter assembly 100. The length of the filter assembly 100 can range from 12 mm to 52 mm, in some embodiments. In some other embodiments, the length of the filter assembly 100 is not particularly limited.

The cavity 122 is configured to receive an adsorbent 130. The porous flow face 110 is coupled to the body 120 across the cavity 122 to isolate the cavity, and therefore the adsorbent 130, from the environment outside of the filter assembly 100. The porous flow face 110 defines both an inlet and an outlet to the filter assembly 100.

The adsorbent 130 is disposed between the porous flow face 110 and the body 120. The adsorbent 130 is generally configured to adsorb chemical contaminants from the cavity 122. The adsorbent 130 can be a physisorbent or chemisorbent material, such as, for example, a desiccant (i.e., a material that adsorbs water or water vapor) or a material that adsorbs or reacts with volatile organic compounds, acid gas, or both. Suitable adsorbents include, for example, activated carbon, activated alumina, molecular sieves, silica gels, potassium permanganate, calcium carbonate, potassium carbonate, sodium carbonate, calcium sulfate, or mixtures thereof. In some embodiments activated alumina is blended with an activated carbon.

The adsorbent 130 can have a variety of structures, not limited to beads, particles, tablets, and the like. The adsorbent 130 can have substantially unbonded constituents or the constituents can be bonded with a binder to itself or another material such as a support scrim. In embodiments where an adsorbent is bonded to a support scrim, the support scrim can be substantially coextensive with the filter material, or the support scrim can be encapsulated by the filter material. Each of the length and height of the adsorbent 130 will be less than or equal to the length and height of the porous flow face 110, in various embodiments. Each of the length and height of the adsorbent 130 will be less than or equal to the length and height of the cavity 122.

In various embodiments, the filter assembly 100 lacks adhesive. The adsorbent 130 can be unbonded to both the body 120 and the porous material 114. The filter assembly 100 can lack adhesive between the adsorbent 130 and the porous material 114. The filter assembly 100 can lack adhesive between the adsorbent 130 and the body 120. Omitting adhesive from the cavity 122 may advantageously allow the cavity 122 to accommodate more adsorbent compared to examples where adhesive is disposed in the cavity 122. In some embodiments, however, adhesive can be used to install the filter assembly 100 in the environment in which it will be used, which will be described below.

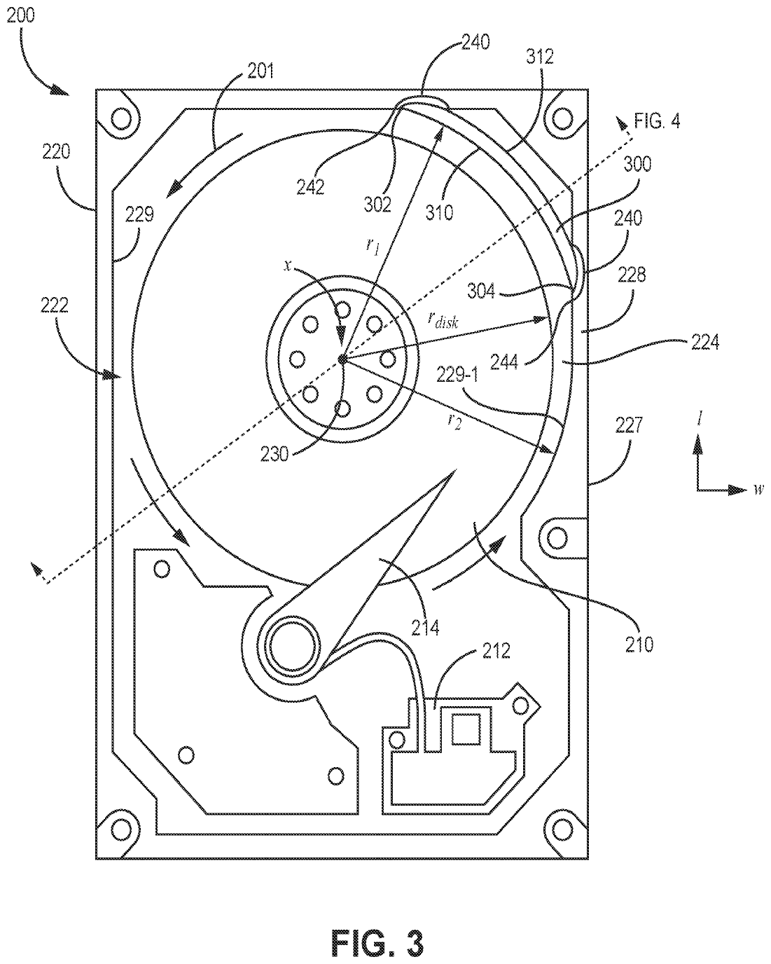

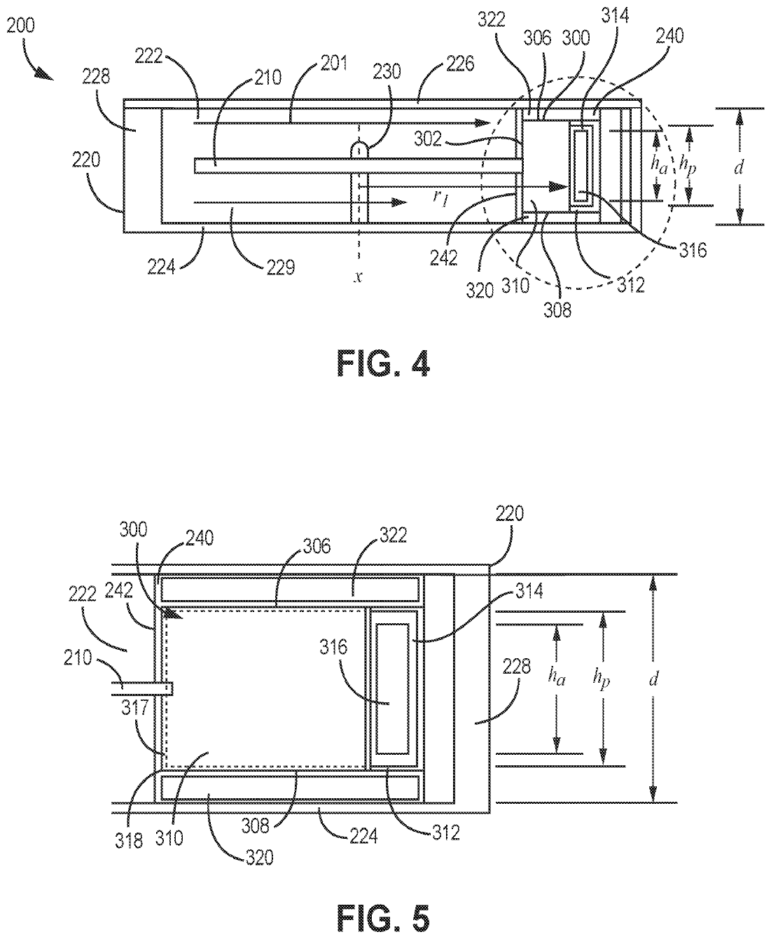

FIG. 3 is a simplified top view of an example electronics enclosure 200 consistent with various embodiments. FIG. 4 is an example cross-sectional view of an electronics enclosure 200 of FIG. 3, and FIG. 5 is a detail view of FIG. 4. In the current example, the electronics enclosure 200 is a disk drive having a disk 210. The electronics enclosure 200 has a housing 220 that defines an enclosure 222 configured to receive the disk 210. A filter assembly 300 is disposed in the enclosure 222.

The disk 210 is configured to be rotatably mounted in the enclosure 222. In particular, the disk is mounted on an axle 230 for rotation within the enclosure 222. In various embodiments, rotation of the disk 210 within the disk drive induces airflow within the enclosure 222. The disk 210 is generally circular and has a central axis x that is co-linear with the axle 230. The disk 210 has a radius r_{disk} that can range from 37 to 115 mm. In some embodiments the radius of the disk r_{disk} is 47.5 mm. Typically, a disk drive will have additional components such as circuitry 212 and a read-write head 214.

The housing 220 is generally configured to house components of the electronics enclosure 200. The housing 220 has a base plate 224 and a cover 226, where the cover is omitted from FIG. 3 for visibility of components, but is visible in FIGS. 4 and 5. The housing 220 has a sidewall 228. The sidewall 228 extends from the base plate 224 to the cover 226. The sidewall 228 defines an inner surface 229, a portion of which is an inner cylindrical surface 229-1 defining an inner cylindrical boundary of the enclosure 222. In various embodiments, the inner cylindrical surface 229-1 is concentric with the disk 210. In various embodiments, the inner cylindrical surface 229-1 is defined about the central axis x. While the current example depicts an inner cylindrical surface 229-1 that is a single circumferential segment about the central axis x, in various embodiments the inner cylindrical surface defines two or more distinct circumferential segments about the disk 210.

The sidewall 228 has an outer housing surface 227. The outer housing surface 227 is not generally limited to a particular shape. While in the current embodiment, the outer housing surface 227 has a rectangular profile (FIG. 2), in some embodiments the outer housing surface 227 can have a profile that is a different shape, such as a square, circle, oval, and the like. The sidewall 228 extends outward from the inner cylindrical surface 229-1 to the outer housing surface 227.

The sidewall 228 defines a filter receptacle 240. The filter receptacle 240 is generally configured to receive a filter assembly 300. The filter receptacle 240 is cumulatively defined by the sidewall 228, the base plate 224 and the cover 226 within the inner surface 229. The filter receptacle 240 can have a variety of different configurations, however.

A filter assembly 300 is disposed in the filter receptacle 240. The filter assembly 300 is generally configured to remove humidity and other chemical contaminants from the enclosure 222. The filter assembly 300 has a porous flow face 310. The porous flow face 310 is configured to accommodate airflow therethrough including water vapor and chemical contaminants.

The filter assembly 300 has a body 312 coupled to the porous flow face 310. The body 312 can be impermeable to fluid flow therethrough. In some embodiments, body 312 can be constructed of a permeable material. In some such embodiments, the sidewall 228 may be configured to abut the body 312 to obstruct fluid flow therethrough. The filter assembly 300 has perimeter edges having a first side edge 302, a second side edge 304, a top edge 306 and a bottom edge 308. The body 312 and the porous flow face 310 are coupled along the perimeter edges. The body 312 and the porous flow face 310 can mutually define the cavity 314 between them. The porous flow face 310 abuts the cavity 314 to allow airflow between the cavity 314 and the environment external to the filter assembly 300.

The filter assembly 300 has an adsorbent 316 disposed between the porous flow face 310 and the body 312. The adsorbent 316 is generally configured to adsorb chemical contaminants from the enclosure 222. The adsorbent 316 can be a variety of types of materials and combinations of materials, which have been discussed above with reference to FIGS. 1-2.

The porous material 318 that defines the porous flow face 310 can be vapor-permeable to allow vapors to pass into the filter assembly 300. Because the porous flow face 310 accommodates diffusion of recirculating airflow through it and the body 312 is impermeable to air flow, the porous flow face 310 defines both an inlet and an outlet of the filter assembly 300. In particular, the porous flow face 310 defines both the inlet and the outlet of the filter assembly 300 for recirculating airflow within the enclosure 222.

The porous flow face 310 is generally configured to allow passage of chemical contaminants from the enclosure 222 to the adsorbent 316. The porous flow face 310 can be a variety of different materials and combinations of materials, which have been described above with reference to FIGS. 1-2. The porous flow face 310 arcs between the first side edge 302 and the second side edge 304 of the filter assembly 300. In various embodiments, the porous flow face 310 defines a portion of an inner cylindrical surface. The porous flow face 310 can define the portion of the inner cylindrical surface across the filter receptacle 240. In some embodiments, the porous flow face 310 can extend the inner cylindrical surface 229-1 of the inner surface 229 across the filter receptacle 240. The curvature of the porous flow face 310 can match the curvature of the inner cylindrical surface 229-1 of the sidewall 228 of the housing 220, in some embodiments. In some embodiments, the porous flow face 310 and the inner cylindrical surface 229-1 are concentric.

The porous flow face 310 can have a radius r₁ about the central axis x. The radius r₁ of the inner cylindrical surface of the porous flow face 310 can range from 44 mm to 100 mm. The radius r₁ of the inner cylindrical surface of the porous flow face 310 can range from 47 mm to 51 mm. In some embodiments the radius r₁ of the inner cylindrical surface of the porous flow face 310 ranges from 48 mm to 50 mm. The porous flow face 310 can have a radius r₁ about the central axis x that is equal to a radius r₂ of the portion of the inner cylindrical surface 229-1 defined by the sidewall 228 about the central axis x. In some embodiments the porous flow face 310 can have a radius r₁ about the central axis x that is unequal to a radius r₂ of the portion of the inner cylindrical surface 229-1. In some alternate embodiments, the porous flow face does not define a portion of an inner cylindrical surface, which is described in more detail below.

Returning to FIGS. 3-5, in use in an electronics assembly 200, the disk 210 is rotated within the enclosure 222 which generates airflow about the enclosure 222. In various implementations of the current technology, the enclosure 222 is configured to encourage laminar airflow of the recirculating air. In some implementations, the enclosure 222 is filled with a gas such as helium to encourage laminar airflow about the enclosure 222. The inner cylindrical surface 229-1 of the housing 220 and disk rotation guides the airflow in generally a circular flow path 201 about the disk 210 (visible in FIG. 3). It has been discovered that, during laminar airflow, contaminants may circulate about the flow path 201 in a particular plane across the depth d of the enclosure 222, thus the flow path 201 can be described as defining a plurality of laminar flow planes across the depth d of the enclosure (visible in FIG. 4).

The porous flow face 310 generally extends across the depth d of the enclosure 222. The porous flow face 310 can be configured to extend across a plurality of laminar flow planes within the enclosure 222. The fact that the porous flow face 310 defines a portion of an inner cylindrical surface and has a radius r₁ can advantageously limit disruption of laminar airflow about the enclosure 222. In particular, such a configuration can limit the generation of turbulent airflow within the enclosure 222.

In various embodiments the first side edge 302 and second side edge 304 of the filter assembly 300 are configured to be flush with a first edge 242 and a second edge 244 of the filter receptacle 240, respectively. The first side edge 302 and second side edge 304 being flush with the first edge 242 and second edge 244 of the filter receptacle 240 can limit the generation of turbulent airflow within the enclosure. By “flush” it is meant that the relevant side edge of the filter assembly 300 abuts the respective edge of the filter receptacle 240 and is circumferentially aligned with the respective edge of the filter receptacle 240 relative to the central axis x.

The airflow that is generally generated about the enclosure 222 during use of the electronics enclosure 200 extends about the length and width of the enclosure (FIG. 3) and also along the entire depth d (FIG. 4) of the enclosure. In various embodiments, the enclosure depth d can be greater than 20.0 mm. The enclosure depth d can be greater than 25.4 mm (1 inch) in some embodiments. The enclosure depth d can range from 18 mm to 90 mm. In some embodiments the enclosure depth d is 21.9 mm (0.86 inches).

In various embodiments, the filter assembly 300 extends between the base plate 224 and the cover 226 of the housing 220. In some embodiments the top edge 306 of the filter assembly 300 abuts the cover 226 and the bottom edge 308 of the filter assembly 300 abuts the base plate 224. In some embodiments the porous flow face 310 has a height hₚ that accommodates a securing mechanism above and/or below the porous flow face 310 to secure the filter assembly 300 to the housing 220. For example, a first gasket, adhesive, or other securing mechanism 322 may be disposed between a top portion of the filter assembly 300 (such as adjacent the top edge 306 of the porous flow face 310) and the cover 226. In some embodiments a second gasket, adhesive, or other securing mechanism 320 may be disposed between a bottom portion of the filter assembly 300 (such as adjacent the bottom edge 308 of the porous flow face 310) and the base plate 224. The first and/or the second securing mechanisms 320, 322 can be a component of the filter assembly 300, in some examples. For example, an adhesive layer 320 or 322 can be coupled to an outer surface of the body 312, such as a top surface of the body (also represented by 306). An adhesive layer can be coupled to the bottom surface of the body 312.

The porous flow face 310 generally has a height hₚ in the x-direction that extends between the bottom edge 308 and the top edge 306 of the body 312. The height hₚ of the porous flow face 310 is generally perpendicular to the disk 210. In embodiments where the filter assembly 300 extends from the cover 226 to the base plate 224, the porous flow face 310 has a height hₚ that is equal to the depth d of the enclosure minus the height of the top edge surface and the bottom edge surface of the body 312 (which are coupled to the perimeter region 317 of the porous material 318).

It has been discovered that a porous flow face 310 that extends a minimum distance relative to the depth d of the enclosure 222 has improved collection efficiency. The height hₚ of the porous flow face 310 is generally greater than 30% of the depth d of the corresponding enclosure 222. The “corresponding enclosure” is the enclosure within which the filter assembly 300 is configured to be installed. In various embodiments the height hₚ of the porous flow face 310 is greater than 50% of the depth d of the corresponding enclosure 222. The height hₚ of the porous flow face 310 can range from 75%-98%, 80%-95%, or 90%-98% of the depth d of the corresponding enclosure. The height hₚ of the porous flow face 310 can range from 80%-99% of the depth d of the corresponding enclosure.

Similarly, it has been discovered that an adsorbent 316 that extends a majority of the depth d of the enclosure 222 has improved collection efficiency. In various embodiments, the adsorbent 316 has a height hₐ that is less than or equal to the height of the porous flow face 310. The height hₐ of the adsorbent 316 is generally perpendicular to the disk 210. The height hₐ of the adsorbent 316 is generally greater than 30% of the depth d of the enclosure 222. In various embodiments the height hₐ of the adsorbent 316 is greater than 50% of the depth d of the enclosure 222. The height hₐ of the adsorbent 316 can range from 75%-98%, 80%-95%, or 90%-98% of the depth d of the enclosure. The height hₐ of the adsorbent 316 can range from 80%-99% of the depth d of the enclosure.

The height hₐ of the adsorbent 316 is generally greater than 6 mm. In various embodiments the height hₐ of the adsorbent 316 can be at least 10 mm. The height hₐ of the adsorbent 316 can be no more than 89 mm. The height hₐ of the adsorbent 316 can range from 15 mm to 89 mm. In some embodiments, the height hₐ of the adsorbent 316 is at least 14 mm, 16 mm, 19 mm, or 22 mm. In some embodiments, the height hₐ of the adsorbent 316 is no more than 25 mm, 35 mm, 45 mm or 50 mm. In some embodiments the height hₐ of the adsorbent 316 ranges from 15 mm to 50 mm.

Various approaches can be employed to secure the filter assembly 300 to the housing 220. As mentioned above, one or more gaskets 320, 322 may be disposed between the housing 220 and the filter assembly 300 in the filter receptacle 240. A gasket can limit shifting of the filter assembly 300 in the housing 220. A gasket can maintain an interference fit between the filter assembly 300 and the housing to limit shifting of the filter assembly 300. In some embodiments, an adhesive can be disposed between the body 312 and the housing 220 within the filter receptacle 240 to secure the filter assembly 300 to the housing 220. In some embodiments a pin can extend between the housing 220 and the filter assembly 300 to secure the filter assembly 300 to the housing 220. In some embodiments the housing 220 can define slide channels that are configured to slidably receive a portion of the filter assembly 300.

In various embodiments, the portion of the inner cylindrical surface 229-1 defined by the sidewall 228 of the housing 220 is configured to be concentric to the disk 210 in the enclosure 222. In various embodiments, the portion of the inner cylindrical surface defined by the porous flow face 310 is configured to be concentric to the disk 210 in the enclosure 222. As such, the inner cylindrical surface 229-1 and the disk 210 can share the central axis x.

It has been discovered that the distance between the porous flow face 310 and the disk 210 can impact filtration efficiency. In some embodiments the radius of the porous flow face r₁ exceeds the radius of the disk r_{disk} by at least 0.25 mm or 0.5 mm. In some embodiments the radius of the porous flow face r₁ exceeds the radius of the disk r_{disk} from 1-7 mm, 1-5 mm or 1-4 mm. In some embodiments the radius of the porous flow face r₁ exceeds the radius of the disk r_{disk} from 2-3 mm. The distance between the porous flow face 310 and the disk 210 can be at least 0.25 mm or 0.5 mm. In some embodiments distance between the porous flow face 310 and the disk 210 can be from 1-7 mm, 1-5 mm or 1-4 mm. In some embodiments distance between the porous flow face 310 and the disk 210 can be from 2-3 mm.

As was mentioned above in the discussion of FIGS. 1 and 2, in some embodiments the body 320 can define an optional breather port 121 (FIG. 2 only) that is configured to accommodate diffusive airflow between the cavity 314 and the outside environment. In such embodiments the breather port can include a diffusion channel extending from the breather port to the cavity 314. In such examples, the diffusion channel generally forms a relatively small opening (for example, less than 3 mm across), that would be inadequate for filtering airflow within the enclosure 222 and, therefore, is not an inlet and outlet for recirculating airflow within the enclosure 222. In various embodiments, the optional breather port 121 may be used for a period of time during the manufacturing and/or use of the disk drive and then is sealed with an adhesive or other sealing component that renders the area across the breather port 121 impermeable to air flow.

In some alternate embodiments, the porous flow face does not define a portion of an inner cylindrical surface. FIG. 6 depicts one example implementation of an electronics enclosure 400 consistent with various embodiments. The electronics enclosure 400 is generally consistent with the description above associated with FIGS. 3-5 except where contradictory. In the current example, the electronics enclosure 400 is a disk drive having a disk 410 rotatably mounted therein. The electronics enclosure 400 has a housing 420 that defines an enclosure 422 configured to receive the disk 410. The housing 420 has a sidewall 428 defining an inner surface 429 having an inner cylindrical surface 429-1, a base plate 424, and a cover that is not currently visible. A filter assembly 500 is disposed in a filter receptacle 440 defined by the sidewall 428 of the enclosure 422.

The filter assembly 500 has a porous flow face 510 coupled to a body 512. The porous flow face 510 and the body 512 mutually define a cavity configured to receive an adsorbent (not currently depicted, but similar to the discussion above of FIGS. 1-2). The porous flow face 510 defines the filter inlet and filter outlet of the filter assembly 500. In the current example, the porous flow face 510 defines a plane. The porous flow face 510 can define a plane. The plane can extend from a first edge 442 of the filter receptacle 440 to a second edge 444 of the filter receptacle 440. The porous flow face 510 is perpendicular to the disk 410. In some embodiments, the porous flow face 510 can be parallel to the tangent 411 of the disk 410 at the location on the disk 410 closest to the porous flow face 510. However, the porous flow face 510 can generally be at an angle of up to 45 degrees relative to the tangent of the disk 410 closest to the porous flow face 510. Other configurations are possible.

Here, a central region 511 of the porous flow face 510 is is configured to be in circumferential alignment with the inner cylindrical surface 429-1, in some embodiments. As such, the radial distance rₕ between the central axis x and the central region 511 of the porous flow face 510 can be equal to the radius r₂ of the inner cylindrical surface 429-1. However, in some embodiments, the radial distance rₕ between the central axis x and the central region 511 of the porous flow face 510 can be unequal to the radius r₂ of the inner cylindrical surface 429-1.

The distance d_{d} between the porous flow face 510 and the disk 410 can be at least 0.25 mm or 0.5 mm. In some embodiments the distance d_{d} between the porous flow face 510 and the disk 410 ranges from 1-7 mm, 1-5 mm or 1-4 mm. In some embodiments the distance d_{d} between the porous flow face 510 and the disk 410 is 2-3 mm. In some embodiments the distance d_{d} between the porous flow face 510 and the disk 410 is 1 mm.

In various embodiments the first side edge surface 502 and second side edge surface 504 of the filter assembly 500 is configured to be flush with the first edge 442 and second edge 444 of the filter receptacle 440, respectively. The first side edge surface 502 and second side edge surface 504 being flush with the first edge 442 and second edge 444 of the filter receptacle 440 may advantageously limit the generation of turbulent airflow within the enclosure 422.

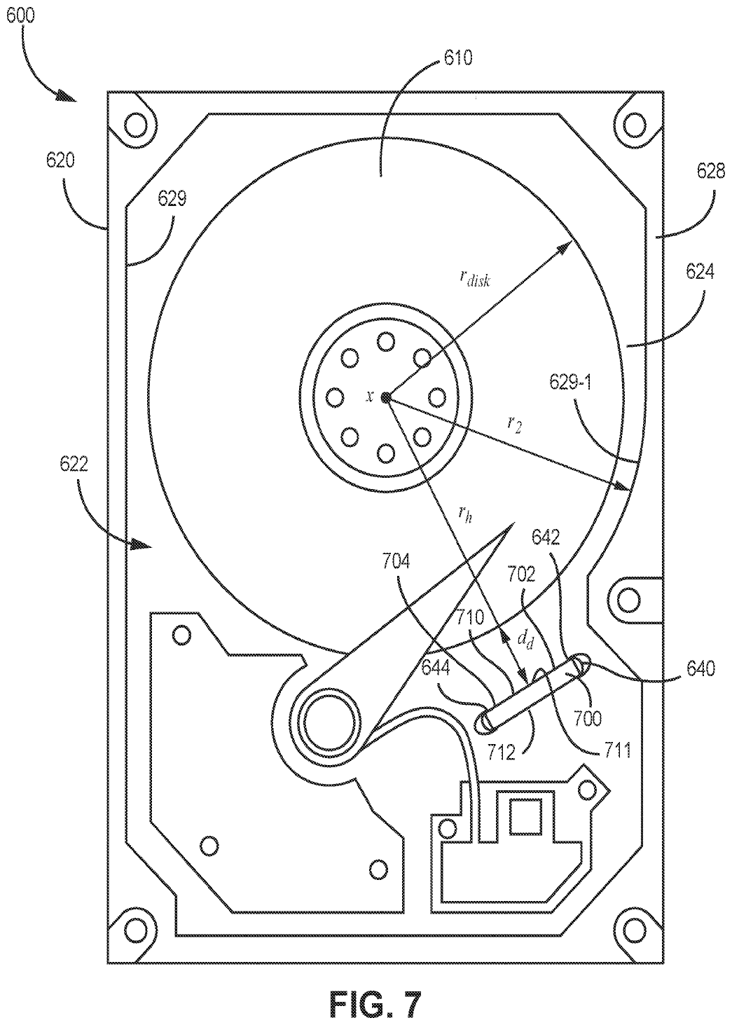

FIG. 7 depicts yet another example implementation of an electronics enclosure 600 consistent with various embodiments. The electronics enclosure 600 is generally consistent with the descriptions above except where contradictory. In the current example, the electronics enclosure 600 is a disk drive having a disk 610 rotatably mounted therein. The electronics enclosure 600 has a housing 620 that defines an enclosure 622 configured to receive the disk 610. The housing 620 has a sidewall 628 defining an inner surface 629 having an inner cylindrical surface 629-1, a base plate 624, and a cover that is not currently visible. A filter assembly 700 is disposed in a filter receptacle 640 of the housing 620.

The filter assembly 700 has a porous flow face 710 coupled to a body 712. The porous flow face 710 and the body 712 mutually define a cavity configured to receive an adsorbent (not currently depicted, but similar to the discussion above of FIGS. 1-2). The porous flow face 710 defines the filter inlet and filter outlet of the filter assembly 700. In the current example, the porous flow face 710 defines a plane, but in some other embodiments, the porous flow face 710 can define an inner cylindrical surface. The porous flow face 710 defines a plane extending from a first edge 642 of the filter receptacle 640 to a second edge 644 of the filter receptacle 640. In the current example, the body 712 has a generally cuboid shape, contrary to previously-depicted examples.

In this example, the porous flow face 710 is not in circumferential alignment with the inner cylindrical surface 629-1. In this example, the porous flow face 710 is not concentric with the disk 610. The radial distance rₕ between the central axis x of the disk 610 and a central region 711 of the porous flow face 710 is greater than the radius r₂ of the inner cylindrical surface 629-1. The distance d_{d} between the porous flow face 710 and the disk 610 can be consistent with the discussion above with reference to FIG. 6.

In various embodiments the first side 702 and second side 704 of the filter assembly 700 is configured to be flush with the first edge 642 and second edge 644 of the filter receptacle 640, respectively. The first side 702 being flush with the first edge 642 and the second side 704 being flush with the second edge 644 of the filter receptacle 640 may advantageously limit the generation of turbulent airflow within the enclosure 622.

Similar to examples described above, the height of the filter assembly 700 generally extends in a direction perpendicular to the disk 610. The filter assembly 700 can have a height consistent with example filter assemblies discussed above. The height of the porous flow face 710 generally extends in a direction perpendicular to the disk 610. The porous flow face 710 can have a height consistent with example porous flow faces discussed above. Similarly, the height of the adsorbent (not currently depicted) generally extends in a direction perpendicular to the disk 610. The adsorbent can have a height consistent with example adsorbents discussed above.

### Experimental Data

Testing was conducted to identify the impact that the orientation of a porous flow face relative to the laminar airflow planes has on the chemical cleanup in a disk drive. Two identical filters were tested. Each filter is an adsorbent web material formed from carbon and an adhesive (the filter did not have a porous flow face or a body). Each filter has an adsorbent flow face having an area of 100.5 mm², a width of 6.7 mm and a length of 15 mm. The adsorbent flow faces were planar. In a first test, a first filter was coupled to the cover within the enclosure where the adsorbent flow face was oriented parallel to the disks and also parallel to the laminar flow planes defined by the airflow within the disk drive. In a second test, the second filter was coupled to the housing within the enclosure and had an orientation perpendicular to the planes defined by the disks, and the length of the adsorbent flow face (15 mm) spanned the depth of the disk drive. The disk drive had a depth of 25.1 mm.

A flow of 30 ml/min of nitrogen with 139 PPM of trimethyl pentane (TMP) was injected into the drive through an injection port in the cover of the disk drive. Air samples were drawn from the drive through a 3 mm sampling port in the drive cover that was 5 mm upstream of the filter and on the outer diameter of the disk. “Upstream” of the recirculation filter is considered to be in the direction opposite of the direction of disk rotation (since spinning the disk is the main driver of airflow within the drive). The injection port was positioned oppositely to the sampling port with respect to the disk drive housing.

Testing was conducted with the disk drive powered on, where the disks were spinning at full speed. Air samples from the sampling port were directed to a Flame Ionization Detector (FID) to measure the TMP concentration at particular time intervals. The time it took to reduce the TMP by 90% of the initial TMP concentration was calculated, which is referred to the T90 cleanup time. The first filter, having a flow face parallel to the laminar flow planes, had a T90 clean-up time of 141.0 seconds. The second filter, having a flow face length of 15 mm spanning the depth of the disk drive, has a T90 clean-up time of 100.7 seconds.

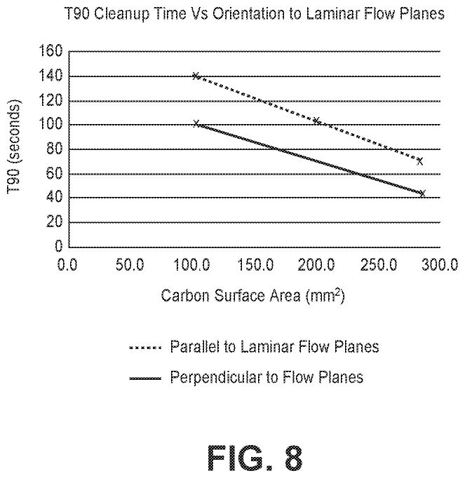

Identical tests were run for additional filters having two different adsorbent flow face areas: (1) 190.2 mm and (2) 285.2 mm. Each of these additional filters had a length of 15 mm. The filter having an adsorbent face area of 190.2 mm was tested in a position coupled to the cover in the enclosure such that the adsorbent flow face was parallel to the planes defined by the disks and also parallel to the laminar flow planes defined by the airflow within the disk drive. The filter having an adsorbent face area of 285.2 mm was tested both (1) in an position coupled to the cover in the enclosure, where the adsorbent flow face was parallel to the planes defined by the disks and also parallel to the laminar flow planes defined by the airflow within the disk drive and (2) in an orientation where the adsorbent flow face had an orientation perpendicular to the planes defined by the disks such that its length (15 mm) extended across the depth of the disk drive. The results are reflected in FIG. 8.

This data appears to demonstrate an advantage associated with orienting the filter flow face to extend across the depth of the electronics enclosure. It is believed that this advantage is particularly pronounced in laminar flow environments, where the air flow pathways are relatively planar about the enclosure and so circulating contaminants may remain at a particular depth (within a particular flow plane) for a greater period of time.

### Restatement of the Embodiments

Embodiment 1. A filter assembly comprising:
a body defining a cavity and having a first side edge surface, a second side edge surface, a top edge surface, and a bottom edge surface forming a perimeter surface around the cavity;
a porous flow face extending across the cavity and coupled to the perimeter surface, wherein the porous flow face arcs between the first side edge surface and the second side edge surface and the porous flow face has a height from the bottom edge to the top edge that is greater than 14 mm; and
an adsorbent disposed in the cavity.
Embodiment 2. The filter assembly of any one of embodiments 1 and 3-13, wherein the adsorbent comprises activated alumina.
Embodiment 3. The filter assembly of any one of embodiments 1-2 and 4-13, wherein the adsorbent comprises carbon.
Embodiment 4. The filter assembly of any one of embodiments 1-3 and 5-13, wherein the porous flow face defines a portion of an inner cylindrical surface.
Embodiment 5. The filter assembly of any one of embodiments 1-4 and 6-13, wherein the porous flow face comprises a microporous membrane.
Embodiment 6. The filter assembly of any one of embodiments 1-5 and 7-13, wherein the body is impermeable.
Embodiment 7. The filter assembly of any one of embodiments 1-6 and 8-13, wherein the porous flow face defines both an inlet and an outlet of the filter assembly.
Embodiment 8. The filter assembly of any one of embodiments 1-7 and 9-13, wherein the porous flow face defines a radius ranging from 47 mm to 51 mm.
Embodiment 9. The filter assembly of any one of embodiments 1-8 and 10-13, wherein the filter assembly lacks adhesive.
Embodiment 10. The filter assembly of any one of embodiments 1-9 and 11-13, wherein the body is rigid.
Embodiment 11. The filter assembly of any one of embodiments 1-10 and 12-13, wherein the body is constructed of plastic.
Embodiment 12. The filter assembly of any one of embodiments 1-11 and 13, further comprising an adhesive layer coupled to an outer surface of the body.
Embodiment 13. The filter assembly of any one of embodiments 1-12, wherein the height of the porous flow face is configured to extend at least 75% of a depth of a corresponding disk drive enclosure.
Embodiment 14. An electronics enclosure comprising:
a housing comprising a base plate, a cover, a filter receptacle, and a sidewall extending from the base plate to the cover to define an enclosure having a depth; and
a filter assembly disposed in the filter receptacle, the filter assembly comprising:
a body defining a cavity and a perimeter surface about the cavity;
a porous flow face extending across the cavity and coupled to the perimeter surface; and
an adsorbent enclosed between the body and the porous flow face, wherein the porous flow face has a height that is at least 60% of the depth of the enclosure, wherein the porous flow face has a height that that is at least 80% of the height of the body.
Embodiment 15. The electronics enclosure of any one of embodiments 14 and 16-28, wherein the porous flow face defines a portion of an inner cylindrical surface across the filter receptacle.
Embodiment 16. The electronics enclosure of any one of embodiments 14-15 and 17-28, wherein a top edge of the filter assembly abuts the cover and the bottom edge of the filter assembly abuts the base plate.
Embodiment 17. The electronics enclosure of any one of embodiments 14-16 and 18-28, wherein the porous flow face defines a plane.
Embodiment 18. The electronics enclosure of any one of embodiments 14-17 and 19-28, wherein the porous flow face is arced between a first side edge and a second side edge of the filter assembly.
Embodiment 19. The electronics enclosure of any one of embodiments 14-18 and 20-28, wherein the porous flow face is concentric to the disk.
Embodiment 20. The electronics enclosure of any one of embodiments 14-19 and 21-28, wherein the adsorbent comprises activated alumina and activated carbon.
Embodiment 21. The electronics enclosure of any one of embodiments 14-20 and 22-28, wherein the porous flow face defines an inlet and an outlet of the filter assembly.
Embodiment 22. The electronics enclosure of any one of embodiments 14-21 and 23-28, wherein the adsorbent has height that spans at least 75% of the enclosure depth.
Embodiment 23. The electronics enclosure of any one of embodiments 14-22 and 24-28, further comprising a gasket disposed in the filter receptacle between the filter assembly and the housing.
Embodiment 24. The electronics enclosure of any one of embodiments 14-23 and 25-28, wherein the porous flow face has a height that spans at least 80% of the enclosure depth.
Embodiment 25. The electronics enclosure of any one of embodiments 14-24 and 26-28, wherein the sidewall defines an inner cylindrical surface.
Embodiment 26. The electronics enclosure of any one of embodiments 14-25 and 27-28, wherein the sidewall defines the filter receptacle.
Embodiment 27. The electronics enclosure of any one of embodiments 14-26 and 28, wherein the filter receptacle is recessed from the inner cylindrical surface.
Embodiment 28. The electronics enclosure of any one of embodiments 14-27, wherein the body is impermeable.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein. For the purpose of the present description and of the appended claims, except where otherwise indicated, all numerical values are to be understood as being modified in all instances by the term “about”. Also, all ranges include the maximum and minimum points disclosed and include any intermediate ranges therein, which may or may not be specifically enumerated herein. In this context, therefore, a value recited herein encompasses deviations of ±3 percent. Within this context, a recited value may be considered to include values that are within general standard error for the measurement of the property that the number modifies.

What is claimed is:

1. A filter assembly comprising:
a body defining a cavity and having a first side edge surface, a second side edge surface, a top edge surface, and a bottom edge surface forming a perimeter surface around the cavity;
a porous flow face extending across the cavity and coupled to the perimeter surface, wherein the porous flow face arcs between the first side edge surface and the second side edge surface and the porous flow face has a height from the bottom edge to the top edge that is greater than 14 mm; and
an adsorbent disposed in the cavity.

2. The filter assembly of any one of claims 1 and 3-13, wherein the adsorbent comprises activated alumina.

3. The filter assembly of any one of claims 1-2 and 4-13, wherein the adsorbent comprises carbon.

4. The filter assembly of any one of claims 1-3 and 5-13, wherein the porous flow face defines a portion of an inner cylindrical surface.

5. The filter assembly of any one of claims 1-4 and 6-13, wherein the porous flow face comprises a microporous membrane.

6. The filter assembly of any one of claims 1-5 and 7-13, wherein the body is impermeable.

7. The filter assembly of any one of claims 1-6 and 8-13, wherein the porous flow face defines both an inlet and an outlet of the filter assembly.

8. The filter assembly of any one of claims 1-7 and 9-13, wherein the porous flow face defines a radius ranging from 47 mm to 51 mm.

9. The filter assembly of any one of claims 1-8 and 10-13, wherein the filter assembly lacks adhesive.

10. The filter assembly of any one of claims 1-9 and 11-13, wherein the body is rigid.

11. The filter assembly of any one of claims 1-10 and 12-13, wherein the body is constructed of plastic.

12. The filter assembly of any one of claims 1-11 and 13, further comprising an adhesive layer coupled to an outer surface of the body.

13. The filter assembly of any one of claims 1-12, wherein the height of the porous flow face is configured to extend at least 75% of a depth of a corresponding disk drive enclosure.

14. An electronics enclosure comprising:
a housing comprising a base plate, a cover, a filter receptacle, and a sidewall extending from the base plate to the cover to define an enclosure having a depth; and
a filter assembly disposed in the filter receptacle, the filter assembly comprising:
a body defining a cavity and a perimeter surface about the cavity;
a porous flow face extending across the cavity and coupled to the perimeter surface; and
an adsorbent enclosed between the body and the porous flow face, wherein the porous flow face has a height that is at least 60% of the depth of the enclosure and wherein the porous flow face has a height that that is at least 80% of the height of the body.

15. The electronics enclosure of any one of claims 14 and 16-28, wherein the porous flow face defines a portion of an inner cylindrical surface across the filter receptacle.

16. The electronics enclosure of any one of claims 14-15 and 17-28, wherein a top edge of the filter assembly abuts the cover and the bottom edge of the filter assembly abuts the base plate.

17. The electronics enclosure of any one of claims 14-16 and 18-28, wherein the porous flow face defines a plane.

18. The electronics enclosure of any one of claims 14-17 and 19-28, wherein the porous flow face is arced between a first side edge and a second side edge of the filter assembly.

19. The electronics enclosure of any one of claims 14-18 and 20-28, wherein the porous flow face is concentric to the disk.

20. The electronics enclosure of any one of claims 14-19 and 21-28, wherein the adsorbent comprises activated alumina and activated carbon.

21. The electronics enclosure of any one of claims 14-20 and 22-28, wherein the porous flow face defines an inlet and an outlet of the filter assembly.

22. The electronics enclosure of any one of claims 14-21 and 23-28, wherein the adsorbent has height that spans at least 75% of the enclosure depth.

23. The electronics enclosure of any one of claims 14-22 and 24-28, further comprising a gasket disposed in the filter receptacle between the filter assembly and the housing.

24. The electronics enclosure of any one of claims 14-23 and 25-28, wherein the porous flow face has a height that spans at least 80% of the enclosure depth.

25. The electronics enclosure of any one of claims 14-24 and 26-28, wherein the sidewall defines an inner cylindrical surface.

26. The electronics enclosure of any one of claims 14-25 and 27-28, wherein the sidewall defines the filter receptacle.

27. The electronics enclosure of any one of claims 14-26 and 28, wherein the filter receptacle is recessed from the inner cylindrical surface.

28. The electronics enclosure of any one of claims 14-27, wherein the body is impermeable.
